(19) United States
(12) Patent Application Publication
(10) Pub. No.: US 2026/0009719 A1
(43) Pub. Date: Jan. 8, 2026

(54) SIMULATION TESTING DEVICE FOR SCOURING AND EROSION DAMAGE OF ACCUMULATION SLOPE UNDER RAINFALL CONDITIONS

(71) Applicant: INSTITUTE OF ROCK AND SOIL MECHANICS, CHINESE ACADEMY OF SCIENCES, WUHAN (CN)

(72) Inventors: Chao ZHANG, WUHAN (CN); Hao LIU, WUHAN (CN); Changkun MA, WUHAN (CN); Xiaogang GUO, WUHAN (CN); Xueqiao HAN, WUHAN (CN); Xueting LI, WUHAN (CN)

(73) Assignee: INSTITUTE OF ROCK AND SOIL MECHANICS, CHINESE ACADEMY OF SCIENCES, WUHAN (CN)

(21) Appl. No.: 19/046,365

(22) Filed: Feb. 5, 2025

(30) Foreign Application Priority Data
Jul. 5, 2024 (CN) 202410897315.4

(51) Int. Cl. G01N 17/00; G06F 30/20; G06F 111/10; G06T 7/00

(52) U.S. Cl. CPC G01N 17/002; G06F 30/20; G06F 2111/10; G06T 7/0004

(57) ABSTRACT

The present invention provides a simulation testing device for scouring and erosion damage of accumulation slope under rainfall conditions, belonging to the field of geotechnical engineering technology. It comprises a water supply subsystem, a rainfall simulation subsystem, and an accumulation slope simulation subsystem. The water supply subsystem comprises a water supply tank and a main water pipe, and the water supply tank can be used to store testing water. The rainfall simulation subsystem comprises a rainfall nozzle, and the accumulation slope simulation subsystem comprises an adjustable slope surface. The outlet of the rainfall nozzle has a first set distance from the adjustable slope surface; The water supply box is communicated to the rainfall nozzle through the main water pipe, and the positive projection of the rainfall nozzle on the adjustable slope comprises the adjustable slope surface, so that the test water can be sequentially dropped onto the adjustable slope surface through the main water pipe and the rainfall nozzle. It can achieve the characterization of damage modes, adjustable slope gradient, and simultaneous consideration of raindrop splash erosion and surface runoff effects in the scouring and erosion damage testing of accumulation slopes, providing the theoretical basis for the inversion and prediction of the entire process of scouring and erosion damage areas in actual engineering.

### TECHNICAL FIELD

The present invention relates to the field of geotechnical engineering technology, in particular to a simulation testing device for scouring and erosion damage of accumulation slope under rainfall conditions.

### BACKGROUND TECHNOLOGY

The subtropical monsoon climate in China is distributed in a vast area south of the Qinling Mountains and Huai River, and cast of the Qinghai Tibet Plateau. The average annual precipitation in this region is generally between 800 mm and 1500 mm, characterized by abundant rainfall, frequent high-intensity rainfall, and long continuous rainfall time. High-intensity rainfall can cause scouring and erosion damage to the slope, changing the infiltration conditions of the slope; High intensity rainfall and long-term rainfall have a significant lifting effect on the infiltration line inside the accumulation body, which may cause the movement of fine particles inside the accumulation body and weaken the strength characteristics of loose accumulation materials, resulting in the slope of the accumulation body in subtropical monsoon climate areas being eroded and damaged by rainfall all year round, leading to a decrease in slope stability. In order to accurately obtain the erosion damage area and progressive instability mode of the slope of the accumulation body under high-intensity or long-term rainfall conditions, there is an urgent need for a simulation testing device for erosion damage of the accumulation body slope that can characterize the damage mode, adjust the slope gradient, and simultaneously consider the effects of raindrop splash erosion and surface runoff.

### SUMMARY OF THE INVENTION

In view of this, the present invention provides a simulation testing device for scouring and erosion damage of accumulation slope under rainfall conditions, which can simulate scouring and erosion damage testing of accumulation slope with characterized failure modes, adjustable slope gradient, and simultaneous consideration of raindrop splash erosion and surface runoff effects. This provides a theoretical basis for the inversion and prediction of the entire process of rainfall scouring and erosion damage on the actual accumulation slope, making it more suitable for practical use.

In order to achieve the above objectives, the technical solution of the simulation testing device for scouring and erosion damage of slope under rainfall conditions provided by the present invention is as follows:

The present invention provides a simulation testing device for scouring and erosion damage of the accumulation slope under rainfall conditions, which comprises a water supply subsystem, a rainfall simulation subsystem, and an accumulation slope simulation subsystem,

The water supply subsystem comprises a water supply tank (19) and a main water pipe (22), wherein the water supply tank (19) can be used to store test water;

The rainfall simulation subsystem comprises a rainfall nozzle (13), and the accumulation slope simulation subsystem comprises an adjustable slope surface (39). The outlet of the rainfall nozzle (13) has a first set distance from the adjustable slope surface (39);

The water supply tank (19) is communicated to the rainfall nozzle (13) through the main water pipe (22), and the forward projection of the rainfall nozzle (13) on the adjustable slope surface (39) includes the adjustable slope surface (39), so that the test water can sequentially fall onto the adjustable slope surface (39) through the main water pipe (22) and the rainfall nozzle (13).

The simulation testing device for scouring and erosion damage of slope under rainfall conditions provided by the present invention can be further implemented using the following technical measures.

As a preferred option, the simulated testing device for scouring and erosion damage of slope deposits under rainfall conditions is characterized by further comprising a horizontal slope surface (40),

The horizontal slope surface (40) is fixedly connected to the adjustable slope surface (39) through one side edge,

The forward projection of the rainfall nozzle (13) on the adjustable slope surface (39) also comprises the horizontal slope surface (40).

As a preferred option, the simulated testing device for scouring and erosion damage of the slope of the accumulation body under rainfall conditions further comprises a slope adjustment mechanism, which comprises a base (48), a first connecting rod (50), a second connecting rod (51), a third connecting rod (61), and a telescopic mechanism (49),

One end of the first connecting rod (50) is fixedly connected to the bottom of the adjustable slope surface (39), and the other end of the first connecting rod (50) is hinged to one end of the third connecting rod (61), forming a guide rail pair between the other end of the third connecting rod (61) and the base (48);

One end of the second connecting rod (51) is fixedly connected to the bottom of the adjustable slope surface (39), and the other end of the second connecting rod (51) forms a guide rail pair with the base (48);

The second link (51) and the third link (61) are hinged at a hinge point, which is set between the two ends of the second link (51), and the hinge point is also set between the two ends of the third link (61);

One end of the telescopic mechanism (49) is fixedly connected to the base (48), and the other end of the telescopic mechanism (49) is hinged to the second connecting rod (51);

Make the connection point between the first connecting rod (50) and the bottom of the adjustable slope surface (39) the first point, and the connection point between the second connecting rod (51) and the bottom of the adjustable slope surface (39) the second point, with a second set distance between the first and second points.

As a preferred option, the bottom of the adjustable slope surface (39) and the horizontal slope surface (40) are sequentially provided with a geomembrane (41) and a rainwater diversion channel (43) from top to bottom.

As a preferred option, the simulation testing device for scouring and erosion damage of the slope of the accumulation body under rainfall conditions further comprises an interception mechanism and a collection subsystem,

The interception mechanism is located downstream of the horizontal slope surface (40), and comprises a first interception part (46) and a second interception part in sequence from top to bottom. The first interception part (46) is physical, and the second interception part is a barrier structure,

The collection subsystem comprises a flushing particle collection tank (23), an erosion particle collection tank (24), and a rainwater collection tank (25),

The first interception part (46) corresponds to the erosion particle collection groove (23), the second interception part corresponds to the erosion particle collection groove (24), and the rainwater diversion groove (43) corresponds to the rainwater collection groove (25).

As a preferred option, the simulated testing device for scouring and erosion damage of the slope of the accumulation body under rainfall conditions further comprises an infiltration line monitoring tube (42),

The infiltration line monitoring tube (42) is arranged between the geomembrane (41) and the rainwater diversion channel (43),

One end of the infiltration line monitoring tube (42) is provided with a first infiltration line monitoring tube connection port (52), which is located on the surface of the adjustable slope surface (39) and the horizontal slope surface (40),

The other end of the infiltration line monitoring tube (42) terminates at the plane where the interception mechanism is located.

As a preferred option, the opening of the collection subsystem gradually narrows from the interception mechanism to the end of the collection subsystem.

As a preferred option, the bottom surface of the rainwater diversion groove (43) is located at the bottom of the horizontal slope surface (40), and the height of the bottom surface of the rainwater diversion groove (43) gradually decreases from the junction of the adjustable slope surface (39) and the horizontal slope surface (40) to the interception mechanism.

As a preferred option, the collection subsystem further comprises a flushing particle guide pipe (26), an erosion particle guide pipe (27), a rainwater guide pipe (28), a flushing particle collection box (29), an erosion particle collection box (30), and a rainwater collection box (31),

The flushing particle collection tank (23) is communicated to the flushing particle collection box (29) through the flushing particle guide pipe (26);

The erosion particle collection tank (24) is communicated to the erosion particle collection box (30) through the erosion particle guide pipe (27);

The rainwater collection tank (25) is communicated to the rainwater collection box (31) through the rainwater diversion pipe (28).

As a preferred option, the simulated testing device for scouring and erosion damage of slope deposits under rainfall conditions further comprises an erosion particle weighing platform (32), an crosion particle weighing platform (33), and rainwater weighing platform (34),

The setting position of the scouring particle weighing platform (32) corresponds to the setting position of the scouring particle collection box (29), and the scouring particle weighing platform (32) is used to weigh the scouring particles collected in the scouring particle collection box (29);

The installation position of the erosion particle weighing platform (33) corresponds to the installation position of the erosion particle collection box (30), and the erosion particle weighing platform (33) is used to weigh the erosion particles collected in the erosion particle collection box (30);

The position of the rainwater weighing platform (34) corresponds to the position of the rainwater collection box (31), and the rainwater weighing platform (34) is used to weigh the rainwater collected in the rainwater collection box (31).

As a preferred option, the simulated testing device for scouring and erosion damage of the slope of the accumulation body under rainfall conditions further comprises a wastewater collection tank (36) and a wastewater communicating pipe (35),

The scouring particle collection box (29), erosion particle collection box (30), and rainwater collection box (31) are respectively communicated to the wastewater collection box (36) through the wastewater communicating pipe (35).

As a preferred option, the simulated testing device for scouring and erosion damage of the slope of the accumulation body under rainfall conditions further comprises a wastewater filter (37),

The wastewater filter screen (37) is installed inside the wastewater collection tank (36), so that the wastewater collection tank (36) is divided into independent first and second storage spaces by the wastewater filter screen (37). The flushing particle collection tank (29), erosion particle collection tank (30), and rainwater collection tank (31) are respectively communicated to the wastewater collection tank (36) through the wastewater communicating pipe (35).

As a preferred option, the simulated testing device for scouring and erosion damage of the slope of the accumulation body under rainfall conditions further comprises a communicating pipe (38) for the water collection tank,

The second storage space is connected to the water supply subsystem through the water collection tank communicating pipe (38).

As a preferred option, the simulation testing device for scouring and erosion damage of the slope of the accumulation body under rainfall conditions further comprises a bracket,

The main water pipe (22) and the rainfall nozzle (13) are set at designated positions through the bracket.

As a preferred option, the simulated testing device for scouring and erosion damage of the slope of the accumulation body under rainfall conditions further comprises a first suspension cable,

The rainfall nozzle (13) and/or the adjustable slope surface (39) are suspended from the bracket by the first suspension cable.

As a preferred option, the simulated testing device for scouring and erosion damage of the slope of the accumulation body under rainfall conditions further comprises a surface runoff pipe (15) and a surface runoff control valve (16),

The water supply tank (19) is communicated to one end of the surface runoff pipe (15) through the main water pipe (22), and the other end of the surface runoff pipe (15) is the surface runoff outlet (18), which is set at the high end of the adjustable slope surface (39).

As a preferred option, the simulation testing device for scouring and erosion damage of the slope of the accumulation body under rainfall conditions further comprises a movable wheel (8),

The mobile casters (8) are set on the support legs of the bracket, so that the bracket can move based on the mobile casters (8).

As a preferred option, the simulation testing device for scouring and erosion damage of accumulation slope under rainfall conditions further comprises an analysis subsystem for the scouring and erosion damage process of accumulation slope. The analysis subsystem for scouring and erosion damage process of accumulation slope comprises:

The second infiltration line monitoring tube connection port is used to obtain monitoring data from the first infiltration line monitoring tube connection port (52);

A laser radar scanner is used to obtain monitoring image data within a monitoring field of view, wherein the monitoring field of view comprises the field of view range of the adjustable slope (39) and/or the horizontal slope (40);

The second suspension cable (54) suspends the laser radar scanner at the set position.

As a preferred option, the simulated testing device for scouring and erosion damage of the slope of the accumulation body under rainfall conditions further comprises a ball joint connector (55),

The second suspension cable (54) is connected to the laser radar scanner through the ball joint connector (55).

As a preferred option, the analysis method of the subsystem for analyzing the scouring and erosion damage process of the slope of the accumulation body comprises the following steps:

Obtain monitoring data from the infiltration line monitoring tube of the adjustable slope surface (39) and/or the horizontal slope surface (40), and/or,

Obtain monitoring image data of the adjustable slope surface (39) and/or the horizontal slope surface (40);

Based on the monitoring data of the infiltration line monitoring tube of the adjustable slope surface (39) and/or the horizontal slope surface (40), and/or the monitoring image data of the adjustable slope surface (39) and/or the horizontal slope surface (40), perform data calculation to obtain the data calculation result;

Based on the data calculation results, obtain the analysis conclusion of the subsystem for analyzing the scouring and erosion damage process of the slope of the accumulation body.

As a preferred method, based on the monitoring data of the infiltration line monitoring tube of the adjustable slope surface (39) and/or the horizontal slope surface (40), and/or the monitoring image data of the adjustable slope surface (39) and/or the horizontal slope surface (40), data calculation is performed to obtain the data calculation result, which specifically comprises the following steps:

Input the monitoring data of the infiltration line monitoring tube of the adjustable slope surface (39) and/or the horizontal slope surface (40), and/or the monitoring image data of the adjustable slope surface (39) and/or the horizontal slope surface (40) into a pre-trained mathematical model;

The mathematical model performs data operations to obtain data operation results.

As a preferred method, the monitoring data of the infiltration line monitoring tube of the adjustable slope surface (39) and/or the horizontal slope surface (40), and/or the monitoring image data of the adjustable slope surface (39) and/or the horizontal slope surface (40) are input into a pre-trained mathematical model. The training method of the pre-trained mathematical model comprises the following steps:

Obtain monitoring data of the infiltration line monitoring tubes of the adjustable slope surface (39) and/or the horizontal slope surface (40), and/or historical monitoring sample data of the monitoring image data of the adjustable slope surface (39) and/or the horizontal slope surface (40), wherein the monitoring data of the infiltration line monitoring tubes of the adjustable slope surface (39) and/or the horizontal slope surface (40), and/or the historical monitoring sample data of the monitoring image data of the adjustable slope surface (39) and/or the horizontal slope surface (40) are historical monitoring sample data with known analysis conclusions;

Input the monitoring data of the infiltration line monitoring tube of the adjustable slope surface (39) and/or the horizontal slope surface (40), and/or the historical monitoring sample data of the monitoring image data of the adjustable slope surface (39) and/or the horizontal slope surface (40) into the selected mathematical model;

Based on the monitoring data of the infiltration line monitoring tube of the adjustable slope surface (39) and/or the horizontal slope surface (40), and/or the analysis conclusion of the historical monitoring sample data of the monitoring image data of the adjustable slope surface (39) and/or the horizontal slope surface (40), adjust the parameters of the selected mathematical model to obtain the pre-trained mathematical model.

As a preferred option, the monitoring data of the infiltration line monitoring tube of the adjustable slope surface (39) and/or the horizontal slope surface (40), and/or the historical monitoring sample data of the monitoring image data of the adjustable slope surface (39) and/or the horizontal slope surface (40) are input into a selected mathematical model, wherein the selected mathematical model comprises multiple.

As a preferred method, the monitoring data of the infiltration line monitoring tube of the adjustable slope surface (39) and/or the horizontal slope surface (40), and/or the monitoring image data of the adjustable slope surface (39) and/or the horizontal slope surface (40) are input into a pre-trained mathematical model. The training method of the pre-trained mathematical model further comprises the following steps:

The monitoring data of the infiltration line monitoring tube of the adjustable slope surface (39) and/or the horizontal slope surface (40) currently being monitored, and/or the monitoring image data of the adjustable slope surface (39) and/or the horizontal slope surface (40), as well as the analysis conclusion of the scouring and erosion damage process of the accumulation slope obtained from the monitoring data of the infiltration line monitoring tube of the adjustable slope surface (39) and/or the horizontal slope surface (40) currently being monitored, are automatically added to the historical monitoring sample data.

The simulation testing device for scouring and erosion damage of accumulation slopes under rainfall conditions provided by the present invention can effectively simulate the observation of the entire process of scouring, erosion, or scouring-erosion coupling progressive damage of accumulation slopes with different slopes under high-intensity or long-term rainfall conditions, providing a theoretical basis for the inversion and prediction of scouring and erosion damage areas of stacked slopes under rainfall conditions.

### DESCRIPTION OF FIGURES

By reading the detailed description of the preferred embodiments in the following text, various other advantages and benefits will become clear to those skilled in the art. The accompanying drawings are only for the purpose of illustrating preferred embodiments and are not to be considered limiting of the present invention. And throughout the entire figure, the same reference symbols are used to represent the same components. In the attached figure:

FIG. 1 is a schematic diagram of a simulation testing device for scouring and erosion damage of a slope under rainfall conditions provided by an embodiment of the present invention;

FIG. 2 is an enlarged partial view of part A in FIG. 1;

FIG. 3 is an enlarged partial view of part B in FIG. 1;

FIG. 4 is an enlarged partial view of part C in FIG. 1;

FIG. 5 is an enlarged partial view of part D in FIG. 1;

FIG. 6 is an enlarged partial view of part E in FIG. 1;

FIG. 7 is an enlarged partial view of section F in FIG. 1;

FIG. 8 is an enlarged partial view of part G in FIG. 1;

FIG. 9 is a schematic diagram of the structural details of the rainfall nozzle used in the simulation test device for scouring and erosion damage of the slope of the accumulation body under rainfall conditions provided in the embodiment of the present invention.

### EMBODIMENT

In view of this, the present invention provides a simulation testing device for scouring and erosion damage of accumulation slope under rainfall conditions, which can simulate scouring and erosion damage testing of accumulation slope with characterized failure modes, adjustable slope gradient, and simultaneous consideration of raindrop splash erosion and surface runoff effects. This provides a theoretical basis for the inversion and prediction of the entire process of rainfall scouring and erosion damage on the actual accumulation slope, making it more suitable for practical use.

In order to further illustrate the technical means and effects adopted by the present invention to achieve the predetermined invention objectives, the following, in conjunction with the accompanying drawings and preferred embodiments, provides a detailed description of the specific implementation, structure, features, and effects of a simulated testing device for scouring and erosion damage of a slope under rainfall conditions proposed by the present invention. In the following explanation, different “embodiments” or “embodiments” do not necessarily refer to the same embodiment. In addition, specific features, structures, or characteristics in one or more embodiments may be combined in any suitable form.

The term “and/or” in this article is only a description of the association relationship between related objects, indicating that there can be three types of relationships, such as A and/or B. The specific understanding is that it can contain both A and B, can exist alone as A, or can exist alone as B, and can have any of the above three situations.

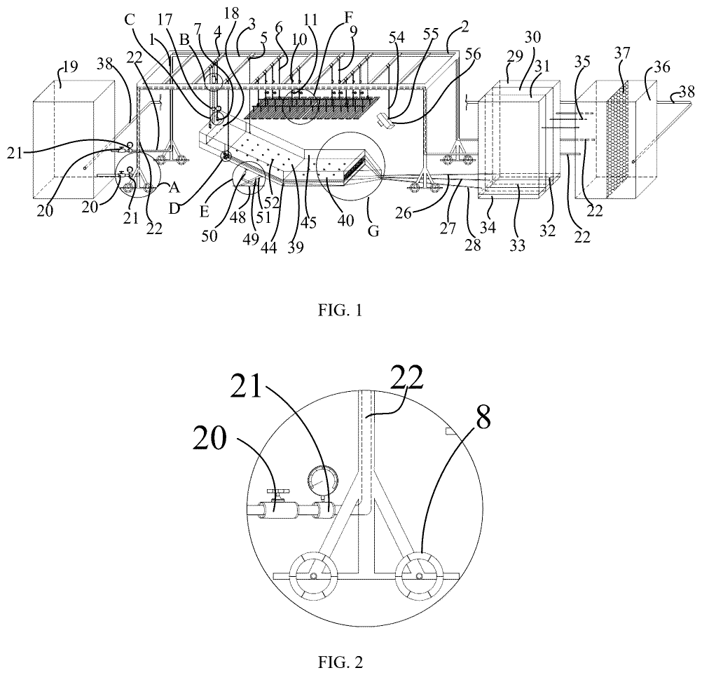

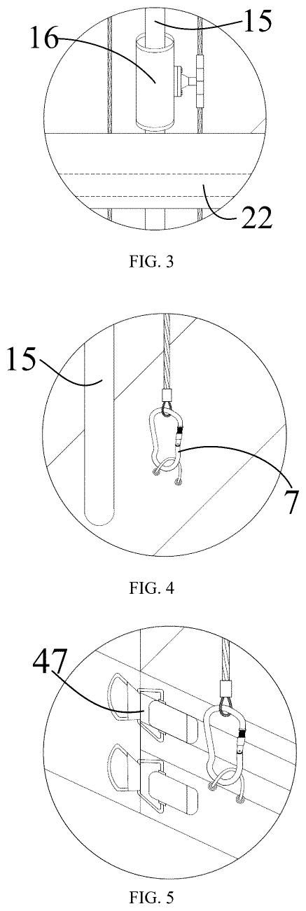

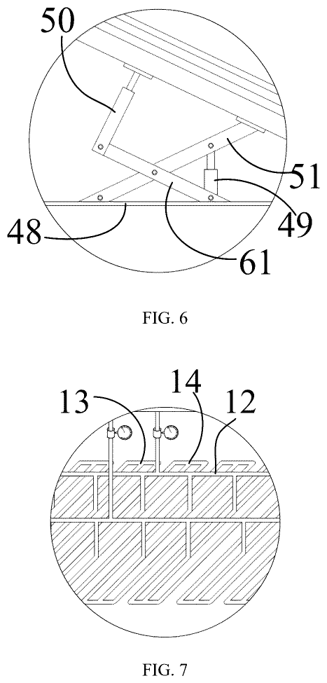

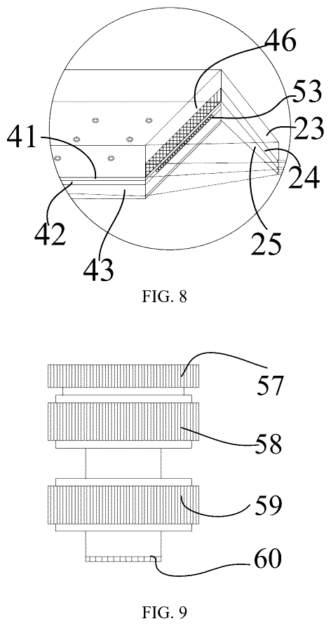

Referring to FIGS. 1 to 9, the simulation testing device for scouring and erosion damage of an accumulation slope under rainfall conditions provided in the embodiments of the present invention comprises a water supply subsystem, a rainfall simulation subsystem, and an accumulation slope simulation subsystem. The water supply subsystem comprises a water supply tank 19 and a main water pipe 22. The water supply tank 19 can be used to store testing water; The rainfall simulation subsystem comprises a rainfall nozzle 13, and the accumulation slope simulation subsystem comprises an adjustable slope surface 39. The outlet of the rainfall nozzle 13 has a first set distance from the adjustable slope surface 39; The water supply tank 19 is communicated to the rainfall nozzle 13 through the main water pipe 22. The positive projection of the rainfall nozzle 13 on the adjustable slope surface 39 comprises the adjustable slope surface 39, so that the test water can be sequentially dropped onto the adjustable slope surface 39 through the main water pipe 22 and the rainfall nozzle 13.

The simulation testing device for scouring and erosion damage of the accumulation slope under rainfall conditions provided in the embodiments of the present invention can effectively simulate the observation of the entire process of being scored, erosion or being scored, and erosion coupling progressive damage of the accumulation slope with different slopes under high-intensity or long-term rainfall conditions, providing a theoretical basis for the inversion and prediction of scouring and erosion damage areas of the accumulation slope under rainfall conditions.

Preferably, the simulation testing device for scouring and erosion damage of the deposited slope under rainfall conditions provided by the embodiments of the present invention further comprises a horizontal slope surface 40. The horizontal slope surface 40 is fixedly connected to the adjustable slope surface 39 through one side edge, and the forward projection of the rainfall nozzle 13 on the adjustable slope surface 39 also comprises the horizontal slope surface 40. In this case, the simulation testing device for scouring and erosion damage of the accumulation slope under rainfall conditions provided by the embodiments of the present invention can simulate the process of rainfall runoff from the slope to the flat ground, which is closer to reality.

Preferably, the simulation testing device for scouring and erosion damage of the accumulation slope under rainfall conditions provided by the embodiments of the present invention further comprises a slope adjustment mechanism, which comprises a base 48, a first connecting rod 50, a second connecting rod 51, a third connecting rod 61, and a telescopic mechanism 49. One end of the first connecting rod 50 is fixedly connected to the bottom of the adjustable slope surface 39, and the other end of the first connecting rod 50 is hinged to one end of the third connecting rod 61, forming a guide rail pair between the other end of the third connecting rod 61 and the base 48; One end of the second connecting rod 51 is fixedly connected to the bottom of the adjustable slope surface 39, and the other end of the second connecting rod 51 forms a guide rail pair with the base 48; The second link 51 and the third link 61 are hinged at a hinge point, which is set between the two ends of the second link 51, and the hinge point is also set between the two ends of the third link 61; One end of the telescopic mechanism 49 is fixedly connected to the base 48, and the other end of the telescopic mechanism 49 is hinged to the second connecting rod 51; Let the connection point between the first link 50 and the bottom of the adjustable slope 39 be the first point, and the connection point between the second link 51 and the bottom of the adjustable slope 39 be the second point, with a second set distance between the first and second points. In this case, the adjustable slope angle 39 of the simulation testing device for scouring and erosion damage of the accumulation slope under rainfall conditions provided by the embodiment of the present invention can be adjusted through the linkage type adjustment mechanism, thereby making the slope angle simulated by the simulation testing device for scouring and erosion damage of the accumulation slope under rainfall conditions provided by the embodiment of the present invention more extensive and adaptable.

Preferably, the bottom of the adjustable slope surface 39 and the horizontal slope surface 40 are sequentially provided with a geomembrane 41 and a rainwater diversion channel 43 from top to bottom. In this case, the use of geomembrane 41 can accurately filter washed and croded particles, reducing their possibility of entering the rainwater diversion channel. Therefore, during the simulation testing process, the simulated rainwater can be accurately screened to obtain more suitable simulation testing results and data.

Preferably, the simulation testing device for scouring and erosion damage of the slope of the accumulation body under rainfall conditions provided by the embodiments of the present invention further comprises an interception mechanism and a collection subsystem. The interception mechanism is located downstream of the horizontal slope surface 40. The interception mechanism comprises a first interception part 46 and a second interception part from top to bottom, where the first interception part 46 is a physical interception part and the second interception part is a barrier structure. The collection subsystem comprises a flushing particle collection tank 23, an erosion particle collection tank 24, and a rainwater collection tank 25. The first interception part 46 corresponds to the erosion particle collection groove 23, the second interception part corresponds to the erosion particle collection groove 24, and the rainwater diversion groove 43 corresponds to the rainwater collection groove 25. In this case, the collection subsystem can utilize the distribution pattern of scouring particle collection tank 23, erosion particle collection tank 24, and rainwater collection tank 25 to achieve layered collection of scouring particles, erosion particles, and rainwater. It can weigh and analyze data separately, which is conducive to the refinement of data analysis.

Preferably, the simulation testing device for scouring and erosion damage of slope under rainfall conditions provided by the embodiments of the present invention further comprises a infiltration line monitoring tube 42. The infiltration line monitoring pipe 42 is arranged between the geomembrane 41 and the rainwater diversion channel 43, such that one end of the infiltration line monitoring pipe 42 is provided with a first infiltration line monitoring pipe connection port 52, which is located on the surface of the adjustable slope 39 and the horizontal slope 40, and the other end of the infiltration line monitoring pipe 42 terminates at the plane where the interception mechanism is located. In this case, the first infiltration line monitoring pipe connection port 52 of the infiltration monitoring pipe 42 can be used to accurately obtain the surface runoff monitoring data to be monitored.

Preferably, the opening of the collection subsystem gradually narrows from the interception mechanism to the end of the collection subsystem. In this case, by collecting the opening shape of the subsystem, the collected scouring particles, erosion particles, and rainwater can be collected at the end of the collection subsystem as much as possible, reducing the direct current of scouring particles, erosion particles, and rainwater in the collection subsystem, thereby increasing the accuracy of the test data of the simulation test device for scouring and erosion damage of the slope of the accumulation body under rainfall conditions provided by the embodiments of the present invention.

Preferably, the bottom of the rainwater diversion groove 43 is located at the bottom of the horizontal slope surface 40, and the height of the bottom of the rainwater diversion groove 43 gradually decreases from the junction of the adjustable slope surface 39 and the horizontal slope surface 40 to the interception mechanism. In this case, the gravity of the rainwater itself can be utilized to ensure that the rainwater flowing into the rainwater diversion channel 43 can be smoothly collected by the rainwater collection box 31.

Preferably, the collection subsystem also comprises scouring particle guide pipe 26, erosion particle guide pipe 27, rainwater guide pipe 28, scouring particle collection box 29, erosion particle collection box 30, and rainwater collection box 31. The flushing particle collection tank 23 is communicated to the flushing particle collection box 29 through a flushing particle guide pipe 26; The erosion particle collection tank 24 is communicated to the erosion particle collection box 30 through an erosion particle guide pipe 27; The rainwater collection tank 25 is communicated to the rainwater collection box 31 through the rainwater diversion pipe 28. In this case, the collected scouring particles, erosion particles, and rainwater by the collection subsystem can enter a larger storage space, thereby making room for the scouring particle collection tank 23, erosion particle collection tank 24, and rainwater collection tank 25 to further receive upstream water.

Preferably, the simulation testing device for scouring and erosion damage of slope under rainfall conditions provided by the embodiments of the present invention further comprises an erosion particle weighing platform 32, an erosion particle weighing platform 33, and a rainwater weighing platform 34. The position of the scouring particle weighing platform 32 corresponds to the position of the scouring particle collection box 29. The scouring particle weighing platform 32 is used to weigh the scouring particles collected in the scouring particle collection box 29; The position of the erosion particle weighing platform 33 corresponds to the position of the erosion particle collection box 30. The erosion particle weighing platform 33 is used to weigh the erosion particles collected in the erosion particle collection box 30; The installation position of rainwater weighing platform 34 corresponds to the installation position of rainwater collection box 31. Rainwater weighing platform 34 is used to weigh the rainwater collected in rainwater collection box 31. In this case, the upstream water from the erosion particle collection tank 23, erosion particle collection tank 24, and rainwater collection tank 25 can be weighed during the transit process, which can improve efficiency and observe the entire process of scouring and erosion damage to the slope of the accumulation body.

Preferably, the simulation testing device for scouring and erosion damage of the slope of the accumulation body under rainfall conditions provided by the embodiments of the present invention further comprises a wastewater collection tank 36 and a wastewater communicating pipe 35. The scouring particle collection box 29, erosion particle collection box 30, and rainwater collection box 31 are respectively communicated to the wastewater collection box 36 through the wastewater connection pipe 35. In this case, the wastewater generated during the simulation testing process of the scouring and erosion damage simulation testing device for the slope of the accumulation body under rainfall conditions provided by the embodiments of the present invention can be collected by the wastewater collection tank 36 to avoid environmental pollution.

Preferably, the simulation testing device for scouring and erosion damage of the slope of the accumulation body under rainfall conditions provided by the embodiments of the present invention further comprises a wastewater filter screen 37. The wastewater filter screen 37 is installed inside the wastewater collection tank 36, so that the wastewater collection tank 36 is divided into independent first and second storage spaces by the wastewater filter screen 37. The flushing particle collection tank 29, erosion particle collection tank 30, and rainwater collection tank 31 are respectively connected to the wastewater collection tank 36 through the wastewater communicating pipe 35. In this case, when upstream water enters the wastewater collection tank 36, particles larger than the pore size of the wastewater filter 37 are intercepted, while water or particles smaller than the pore size of the wastewater filter 37 can be thrown into the second storage space, facilitating solid-liquid separation of the wastewater.

Preferably, the simulation testing device for scouring and erosion damage of the slope of the accumulation body under rainfall conditions provided by the embodiments of the present invention further comprises a communicating pipe 38 for the water collection tank. The second storage space is connected to the water supply subsystem through the water collection tank communicating pipe 38. In this case, it is possible to recycle the wastewater, thereby reducing the amount of testing materials and saving resources.

Preferably, the simulation testing device for scouring and erosion damage of slope under rainfall conditions provided by the embodiments of the present invention further comprises a bracket. The main water pipe 22 and the rainfall nozzle 13 are set at designated positions through brackets. In this case, the water pipe 22 and the rainfall nozzle 13 can be arranged reasonably and do not require personnel to be on duty.

Preferably, the simulation testing device for scouring and erosion damage of slope under rainfall conditions provided by the embodiments of the present invention further comprises a first suspension cable. The rainfall nozzle 13 and/or the adjustable slope 39 are suspended from the bracket by a first suspension cable. In this case, by suspending the rainfall nozzle 13 and/or the adjustable slope surface 39, it is possible to make the state of the simulated testing device for scouring and erosion damage of the deposited slope under rainfall conditions provided by the embodiments of the present invention more stable during the experimental operation.

Preferably, the simulation testing device for scouring and erosion damage of the slope of the accumulation body under rainfall conditions provided by the embodiments of the present invention further comprises a surface runoff pipe 15 and a surface runoff control valve 16. The water supply tank 19 is connected to one end of the surface runoff pipe 15 through the main water pipe 22, and the other end of the surface runoff pipe 15 is the surface runoff outlet 18, which is set at the high end of the adjustable slope 39. In this case, the flow rate and velocity on the adjustable slope surface 39 and the horizontal slope surface 40 can be adjusted through the surface runoff pipe 15 and the surface runoff control valve. Therefore, the simulation adaptability of the scouring and erosion damage simulation testing device for slope erosion under rainfall conditions provided by the embodiments of the present invention is more extensive.

Preferably, the simulation testing device for scouring and erosion damage of the slope of the accumulation body under rainfall conditions provided by the embodiment of the present invention further comprises a movable wheel 8. The mobile casters 8 are set on the support legs of the bracket, allowing the bracket to move based on the mobile casters 8. In this case, the movement of the simulation testing device for scouring and erosion damage of the slope under rainfall conditions provided by the embodiments of the present invention is more convenient.

Preferably, the simulation testing device for scouring and erosion damage of the accumulation slope under rainfall conditions provided by the embodiments of the present invention further comprises an analysis subsystem for the scouring and erosion damage process of the accumulation slope. The analysis subsystem for the scouring and erosion damage process of the accumulation slope comprises:

The second infiltration line monitoring tube connection port is used to obtain monitoring data from the first infiltration line monitoring tube connection port 52;

Lidar scanner, used to obtain monitoring image data within the monitoring field of view, wherein the monitoring field of view comprises the field of view range of adjustable slope 39 and/or horizontal slope 40;

The second suspension cable 54 suspends the LiDAR scanner at the set position.

In this case, the simulation testing device for scouring and erosion damage of the slope of the accumulation body under rainfall conditions provided by the embodiment of the present invention can use the data obtained from the second infiltration line monitoring pipe connection port and the laser radar scanner for remote data analysis, thus achieving unmanned operation and saving efficiency.

Preferably, the simulation testing device for scouring and erosion damage of the slope of the accumulation body under rainfall conditions provided by the embodiment of the present invention further comprises a ball joint connection 55, and the second suspension cable 54 is connected to the laser radar scanner 56 through the ball joint connection 55. In this case, the laser scanner 56 used in the simulation test device for scouring and erosion damage of the slope of the accumulation body under rainfall conditions provided by the embodiment of the present invention can rotate at multiple angles with the assistance of the ball head connector 55. In this embodiment, the ball head connector 55 can also be equipped with a control command receiving interface, through which remote control of the ball head connector 55 can be achieved. Therefore, the rotation of the laser scanner 56 can be made more flexible and convenient.

The analysis method for the subsystem of scouring and erosion damage process analysis of the slope of the accumulation body comprises the following steps:

Step S1: Obtain monitoring data from the infiltration line monitoring tube of adjustable slope surface 39 and/or horizontal slope surface 40, and/or obtain monitoring image data of adjustable slope surface 39 and/or horizontal slope surface 40;

Step S2: Based on the monitoring data of the infiltration line monitoring tube of the adjustable slope surface 39 and/or the horizontal slope surface 40, and/or the monitoring image data of the adjustable slope surface 39 and/or the horizontal slope surface 40, perform data calculation to obtain the data calculation result;

Step S3: Based on the data calculation results, obtain the analysis conclusion of the analysis subsystem for the scouring and erosion damage process of the slope of the accumulation body.

In this case, the analysis of the scouring and erosion damage process of the slope of the accumulation body can be completed through computer software, with more accurate calculations and higher efficiency.

Preferably, step S2 performs data calculation based on the monitoring data of the infiltration line monitoring tube of the adjustable slope surface 39 and/or the horizontal slope surface 40, and/or the monitoring image data of the adjustable slope surface 39 and/or the horizontal slope surface 40, and obtains the data calculation result, which specifically comprises the following steps:

Step S21: Input the monitoring data of the infiltration line monitoring tube of adjustable slope 39 and/or horizontal slope 40, and/or the monitoring image data of adjustable slope 39 and/or horizontal slope 40 into the pre-trained mathematical model;

Step S22: The mathematical model performs data operations to obtain the results of the data operations.

In this case, by pre-training a mathematical model, not only can the computational efficiency be improved, but the degree of conformity between the computational results and the actual situation can also be higher, making the simulation results of the scouring and erosion damage simulation test device for slope erosion under rainfall conditions provided by the embodiments of the present invention more valuable for reference.

Preferably, step S21 inputs the monitoring data of the infiltration line monitoring tube of the adjustable slope surface 39 and/or the horizontal slope surface 40, and/or the monitoring image data of the adjustable slope surface 39 and/or the horizontal slope surface 40 into the pre-trained mathematical model. The training method of the pre-trained mathematical model comprises the following steps:

Step S211: Obtain monitoring data from the infiltration line monitoring tubes of the adjustable slope surface 39 and/or the horizontal slope surface 40, and/or historical monitoring sample data from the monitoring image data of the adjustable slope surface 39 and/or the horizontal slope surface 40, where the monitoring data from the infiltration line monitoring tubes of the adjustable slope surface 39 and/or the horizontal slope surface 40, and/or the historical monitoring sample data from the monitoring image data of the adjustable slope surface 39 and/or the horizontal slope surface 40 are historical monitoring sample data with known analysis conclusions;

Step S212: Input the monitoring data of the infiltration line monitoring tube of adjustable slope 39 and/or horizontal slope 40, and/or the historical monitoring sample data of the monitoring image data of adjustable slope 39 and/or horizontal slope 40 into the selected mathematical model;

Step S213: Based on the monitoring data of the infiltration line monitoring tube on the adjustable slope surface 39 and/or the horizontal slope surface 40, and/or the analysis conclusion of the historical monitoring sample data of the monitoring image data on the adjustable slope surface 39 and/or the horizontal slope surface 40, adjust the parameters of the selected mathematical model to obtain a pre-trained mathematical model.

In this case, by learning from historical monitoring sample data, the obtained mathematical model can be made more accurate, thereby increasing the reference value of the simulation results of the scouring and erosion damage simulation testing device for slope erosion under rainfall conditions provided by the embodiments of the present invention.

Preferably, in step S212, the monitoring data of the infiltration line monitoring tube of the adjustable slope surface 39 and/or the horizontal slope surface 40, and/or the historical monitoring sample data of the monitoring image data of the adjustable slope surface 39 and/or the horizontal slope surface 40 are input into the selected mathematical model, which comprises multiple mathematical models. In this case, after training with multiple mathematical models, the optimal mathematical model can be selected for the current simulation, making the simulation results of the scouring and erosion damage simulation testing device for slope erosion under rainfall conditions provided by the embodiments of the present invention more valuable for reference.

Preferably, step S21 inputs the monitoring data of the infiltration line monitoring tube of the adjustable slope surface 39 and/or the horizontal slope surface 40, and/or the monitoring image data of the adjustable slope surface 39 and/or the horizontal slope surface 40 into the pre-trained mathematical model. The training method of the pre-trained mathematical model also comprises the following steps:

Step S214: The monitoring data of the infiltration line monitoring tube of the currently monitored adjustable slope surface 39 and/or horizontal slope surface 40, and/or the monitoring image data of the adjustable slope surface 39 and/or horizontal slope surface 40, as well as the analysis conclusion of the slope scouring and erosion damage process analysis subsystem of the accumulation body obtained based on the monitoring data of the infiltration line monitoring tube of the currently monitored adjustable slope surface 39 and/or horizontal slope surface 40, and/or the monitoring image data of the adjustable slope surface 39 and/or horizontal slope surface 40, are automatically added to the historical monitoring sample data. In this case, the current sample can be continuously added to the historical monitoring sample data, and as the training sample data of the mathematical model increases, the adaptability of the parameters of the mathematical model to the real situation becomes more extensive.

In addition, the beneficial effects of the present invention can also be specifically:

Firstly, in the rainfall simulation subsystem, surface runoff simulation subsystem, and water supply and collection subsystem of the present invention, the total valve, rainfall control valve, and surface runoff control valve are used to adjust the rainfall amount, surface runoff velocity, and flow rate. The rainfall nozzle is used to adjust the intensity, range, and position of rainfall spraying, thereby achieving simulation of high-intensity rainfall conditions; The atmospheric rainfall cycle simulation system is composed of a main water pipe, a wastewater collection tank, a communicating pipe for the water supply and collection tank, and a series connection for the water supply tank, ensuring that the simulation device can continuously supply water for a long time, thus achieving the simulation of long-term rainfall conditions. Furthermore, through infiltration line monitoring devices, particle transport monitoring devices, the accumulation deformation monitoring devices, and pore water pressure monitoring devices, real-time quantitative characterization of the damage location and gradual damage process of the accumulation under simulated high-intensity rainfall or long-term rainfall conditions under erosion, erosion, or erosion coupling effects can be achieved.

Secondly, in the support system, accumulation slope simulation subsystem, and slope adjustment subsystem of the present invention, the adjustable slope surface is connected to the slope adjustment subsystem, and the hydraulic height adjustment rod, hydraulic slope adjustment rod, and slope support inclined rod work together to adjust the slope gradient; At the same time, there are steel wire rope buckles and buckles on both sides of the adjustable slope surface. The steel wire rope buckles are connected to the steel wire rope in the support system, thereby ensuring the stability of the adjustable slope surface and achieving stable adjustment of the slope gradient.

Thirdly, the present invention achieves the simulation of the scouring and erosion damage process of the accumulation slope under the coupling of raindrop splash erosion, surface runoff, or raindrop splash erosion surface runoff coupling through the collaborative action of the rainfall simulation subsystem and the surface runoff simulation subsystem, thereby forming an accumulation slope scouring and erosion damage simulation testing device and method that can characterize the damage mode, adjust the slope gradient, and simultaneously consider the effects of raindrop splash erosion and surface runoff.

### EXAMPLE 1

The simulation testing device for scouring and erosion damage of a slope under rainfall conditions proposed in Example 1 of the present invention mainly consists of 8 parts, namely: support system, rainfall simulation subsystem, surface runoff simulation subsystem, water supply subsystem, rainwater particle mixture collection subsystem, slope simulation subsystem, slope adjustment subsystem, and slope scouring and erosion damage process analysis subsystem.

The support system comprises a support column 1, a horizontal crossbeam 2, a crossbeam groove 3, a movable crossbeam 4, and universal wheels 8. The height of the support column 1 is 2.5 meters, the length of the water balance beam 2 is 4 meters, the length of the crossbeam groove 3 is 4 meters, and the length of the movable crossbeam 4 is 1.5 meters; The movable crossbeam 4 overlaps with the crossbeam groove 3, and by embedding seven movable crossbeams 4 in the crossbeam groove 3, the functional requirements and position adjustment of the rainfall simulation subsystem, surface runoff subsystem, and accumulation slope simulation subsystem can be achieved; The movable crossbeam 4 is equipped with a buckle 5, which is used to fix the steel wire rope 6. The length of the steel wire rope 6 can be adjusted according to experimental requirements; The lower end of wire rope 6 is connected to wire rope buckle 7, which is used to fix the surface runoff subsystem, rainfall simulation subsystem, and slope adjustment subsystem respectively; The auxiliary fixed surface runoff subsystem is suspended by 2 steel wire ropes with a length of 1.5 m, the auxiliary fixed slope adjustment subsystem is suspended by 2 steel wire ropes with a length of 1.75 m, and the auxiliary fixed rainfall simulation subsystem is suspended by 8 steel wire ropes with a length of 0.75 m; The bracket system can be moved through universal wheels 8.

The rainfall simulation subsystem comprises a rainfall water pipe 9, a rainfall control valve 10, and a rainfall flow meter 11. The rainfall water pipe 9 is connected to the water supply subsystem, and the rainfall water pipe 9 is connected to the rainfall control valve 10 and the rainfall flow meter 11. The rainfall flow meter 11 can display the real-time rainwater flow rate, and the rainfall control valve 10 can adjust the rainfall amount; The rainfall water pipes 9 in the rainfall simulation subsystem are equipped with rainfall control valves 10, which can respectively control the water supply of the rainfall water pipes 9; The lower part of the rainwater pipe 9 is connected to the rainwater distribution pipe 12, and the rainwater distribution pipe 12 is connected to the rainfall nozzle 13. A rainfall nozzle 14 is installed at the bottom of the rainfall nozzle 13; In the rainfall nozzle 14, it is fixedly connected to the rainfall nozzle 13 through the nozzle fixing knob 57. The rainfall intensity adjustment knob 58 adjusts the rainfall intensity of the nozzle 60, and the rainfall spraying range adjustment knob 59 adjusts the spraying range of the nozzle 60. The rainfall nozzle 14 can adjust the rainfall spraying intensity, range, and position according to experimental needs, thus achieving simulation of high-intensity rainfall conditions.

The surface runoff simulation subsystem comprises a surface runoff pipe 15, which is connected to a surface runoff control valve 16 and a surface runoff flow meter 17. The surface runoff flow meter 17 can display the surface runoff flow rate in real time, and the surface runoff control valve 16 can adjust the size of the surface runoff flow rate. The bottom of the surface runoff pipe 15 is connected to the surface runoff outlet 18, and the surface runoff velocity and flow rate can be adjusted through the surface runoff outlet 18. There are transparent baffles 45 on both sides of the surface runoff outlet, which can observe the surface runoff velocity and flow rate in real time.

The water supply subsystem comprises a water supply tank 19, which has a length, width, and height of 1 m, 1 m, and 2 m respectively. The water supply tank 19 is connected to a main water pipe 22, which is arranged on both sides of the support system. The main water pipe 22 is connected to a main valve 20 and a main flow meter 21. The main flow meter 21 can display the real-time water supply volume, and the main valve 20 can adjust the water volume; The main water pipe 22 is connected to the rainfall water pipe 9 in the rainfall simulation subsystem and the surface runoff water pipe 15 in the surface runoff simulation subsystem.

The rainwater particle mixture collection subsystem comprises a scouring particle collection tank 23, an erosion particle collection tank 24, and a rainwater collection tank 25. The scouring particle collection tank 23 is located at the top layer, the erosion particle collection tank 24 is located at the middle layer, and the rainwater collection tank 25 is located at the bottom layer. The scouring particle collection tank 23, the erosion particle collection tank 24, and the rainwater collection tank 25 overlap with each other and are sealed around; The flushing particle collection tank 23 is connected to the flushing particle guide pipe 26, which guides the flushed particles into the flushing particle collection box 29. The bottom of the flushing particle collection box 29 is equipped with a flushing particle weighing platform 32, which can display the weight of the flushed particles in real time; The erosion particle collection tank 24 is connected to the erosion particle guide pipe 27, which guides the eroded particles into the erosion particle collection box 30. The bottom of the erosion particle collection box 30 is equipped with an crosion particle weighing platform 33, which can display the weight of the eroded particles in real time; The rainwater collection tank 25 is connected to the rainwater diversion pipe 28. The rainwater diversion pipe 28 guides the accumulation rainwater into the rainwater collection box 31. The bottom of the rainwater collection box 31 is equipped with a rainwater weighing platform 34, which can display the weight of the accumulation rainwater in real time; The length, width, and height of the scouring particle collection box 29, erosion particle collection box 30, and rainwater collection box 31 are 1 m, 1 m, and 2 m, respectively. The scouring particle collection box 29, erosion particle collection box 30, and rainwater collection box 31 are connected to the wastewater connection pipe 35, which is connected to the wastewater collection box 36. The wastewater collection box 36 is equipped with a wastewater filter screen 37 inside, which is used to prevent the collected rainwater bulk material mixture from blocking the rainfall simulation device and surface runoff device. The interface of the water supply collection tank connection pipe 38 is set on the right side of the wastewater filter screen 37, and the water supply tank connection pipe 38 is connected to the wastewater collection box 36 and the water supply box 19 respectively.

The other end of the main water pipe 22 in the water supply subsystem is connected to the wastewater collection tank 36. The wastewater collection tank 36 is connected to the communicating pipe 38 of the water supply collection tank, and the communicating pipe 38 of the water supply collection tank is connected to the water supply tank 19. The main water pipe 22, the wastewater collection tank 36, the communicating pipe 38 of the water supply collection tank, and the water supply tank 19 form an atmospheric precipitation cycle simulation system, ensuring that the simulation device can continuously supply rainfall for a long time, thereby achieving simulation of long-term rainfall conditions; The scouring particle collection tank 23, crosion particle collection tank 24, and rainwater collection tank 25 are arranged at a certain inclination angle of 15-25°. The scouring particle guide pipe 26, erosion particle guide pipe 27, and rainwater guide pipe 28 are arranged at a certain inclination angle of 15-25° to ensure that particles and rainwater flow (slide) into the collection box; The scouring particle collection box 29, erosion particle collection box 30, and rainwater collection box 31 are made of transparent acrylic sheets with scale lines on the side for real-time monitoring of the volume of scouring particles, erosion particles, and rainwater.

The simulation subsystem for the accumulation slope comprises an adjustable slope surface 39 and a horizontal slope surface 40. The adjustable slope surface 39 has a length of 1 m, a width of 1 m, and a thickness of 0.4 m, while the horizontal slope surface 40 has a length of 1 m, a width of 1 m, and a thickness of 0.4 m; The adjustable slope surface 39 is equipped with steel wire rope buckles 7 and buckles 47 on both sides. The steel wire rope buckles 7 and 6 are connected to the support system to ensure the stability of the adjustable slope surface; There are infiltration line monitoring pipe connection ports 52 in the adjustable slope surface 39 and the horizontal slope surface 40. The lower part of the infiltration line monitoring pipe connection port 52 is attached with a geomembrane 41, which is used to prevent loose particles from entering the lower part of the adjustable slope surface 39 and the horizontal slope surface 40; The lower part of the geomembrane 41 is equipped with a infiltration line monitoring pipe 42, and the lower part of the infiltration line monitoring pipe 42 is equipped with a rainwater diversion channel 43; The infiltration line monitoring tubes 42 are evenly distributed on the adjustable slope surface 39 and the horizontal slope surface 40, and the angle of the infiltration line monitoring tubes is parallel to the slope surface; Rainwater diversion channel 43 is used to collect rainwater seepage from the accumulation body, and is arranged at a 15-25° inclination angle at the bottom of the horizontal slope surface; There is a slope bearing 44 between the adjustable slope surface 39 and the horizontal slope surface 40, transparent baffles 45 on both sides of the adjustable slope surface 39 and the horizontal slope surface 40, and a stacking baffle 46 at the tail of the horizontal slope surface 40. The adjustable slope surface 39 is connected and fixed to the surface runoff subsystem through a buckle 47; In the simulation subsystem of the accumulation slope, there are small pores in the accumulation baffle 46, with pore sizes slightly larger than the maximum particle size of the loose accumulation material. The accumulation baffle can resist the overall sliding of the accumulation and ensure that the erosion particles are transported to the erosion particle collection tank.

The slope adjustment subsystem comprises a hydraulic height adjustment rod 49 and a hydraulic slope adjustment rod 50, which are connected to a slope support inclined rod 51. The slope support inclined rod 51 and the hydraulic height adjustment rod 49 are connected to a base support groove 48, and the slope support inclined rod 51 can move within the base support groove 48; The adjustable slope surface 39 in the accumulation slope simulation subsystem is connected to the slope adjustment subsystem. The hydraulic height adjustment rod 49, hydraulic slope adjustment rod 50, and slope support inclined rod 51 work together to adjust the slope gradient, with a range of 0-45°.

The analysis subsystem for the scouring and erosion damage process of the slope of the accumulation body comprises a infiltration line monitoring device, a particle transport monitoring device, an accumulation body deformation monitoring device, and a pore water pressure monitoring device. The infiltration line monitoring device comprises a infiltration line monitoring pipe connection port 52 and a infiltration line monitoring data outlet port 53; The particle transport monitoring device comprises a scouring particle weighing platform 32, an erosion particle weighing platform 33, and a rainwater weighing platform 34; The deformation monitoring device for the accumulation body comprises an equipment hanger 54, a ball head connection port 55, and a laser radar scanner 56. The equipment hanger 54 is connected to the movable crossbeam 4 in the support system, and the ball head connection port 55 is connected to the laser radar scanner 56. The height (range of 0.5-2.0 m) and angle (range of 0-360°) monitored by the laser radar scanner 56 can be adjusted through the equipment hanger 54 and the ball head connection port 55; The pore water pressure monitoring device is uniformly arranged inside the accumulation body; The infiltration line monitoring device, particle transport monitoring device, accumulation deformation monitoring device, and pore water pressure monitoring device are connected to a computer for real-time acquisition of relevant monitoring data.

### EXAMPLE 2

Corresponding to the simulation testing device for scouring and erosion damage of accumulation slope under rainfall conditions in Example 1 of the present invention, Example 2 provides a simulation experimental method for the scouring and erosion damage process of accumulation slope surface under high-intensity rainfall conditions, comprising:

Simulation of high-intensity rainfall and surface runoff conditions: Open the main valve 20 in the water supply subsystem, adjust the rainfall control valve 10 in the rainfall simulation subsystem and the surface runoff control valve 16 in the surface runoff simulation subsystem; Place a rainfall gauge at the bottom of the rainfall simulation device, adjust the rainfall intensity adjustment knob 58, rainfall spray range adjustment knob 59, and nozzle 60 according to the experimental design plan, so that the rainfall reaches 300-800 mm/24 h; Convert surface runoff flow rate and velocity based on the set rainfall amount, and adjust them through surface runoff control valve 16.

Slope surface simulation of different slope accumulation bodies: The slope angle of adjustable slope surface 38 can be controlled through the slope adjustment subsystem, and the angle can be set from 0 to 45 degrees; Spread the loose material evenly on the adjustable slope surface 38, with a thickness of 0.1-0.3 m. The particle size of the loose material can be uniformly graded or single graded, or adjusted according to the actual engineering situation.

Analysis of the scouring and erosion damage process of the slope of the accumulation body: comprising the placement of the erosion particle collection groove 23 and the rainwater collection groove 25 at the tail of the horizontal slope surface 40, the connection between the erosion particle collection groove 23 and the surface of the horizontal slope surface 40 for collecting erosion particles, the overlapping of the erosion particle collection groove 23 and the rainwater collection groove 25, and the sealing around them; The flushing particle collection tank 23 is connected to the flushing particle guide pipe 26, which guides the flushed particles into the flushing particle collection box 29. The bottom of the flushing particle collection box 29 is equipped with a flushing particle weighing platform 32, which can display the weight of the flushed particles in real time; The rainwater collection tank 25 is connected to the rainwater diversion pipe 28. The rainwater diversion pipe 28 guides the accumulation rainwater into the rainwater collection box 31. The bottom of the rainwater collection box 31 is equipped with a rainwater weighing platform 34, which can display the weight of the accumulation rainwater in real time; The deformation monitoring device for the accumulation body comprises an equipment hanger 54, a ball head connection port 55, and a laser radar scanner 56. The equipment hanger 54 is connected to the movable crossbeam 4 in the support system, and the ball head connection port 55 is connected to the laser radar scanner 56. The monitoring height and angle of the laser radar scanner 56 can be adjusted through the equipment hanger 54 and the ball head connection port 55. The laser radar scanner 56 can monitor the starting and transportation process of loose accumulation material particles and the scouring and erosion damage process of the slope in real time; The particle transport monitoring device and the accumulation deformation monitoring device are connected to a computer for real-time acquisition of relevant monitoring data.

### EXAMPLE 3

Corresponding to the simulation testing device for scouring and erosion damage of loose accumulation slope under rainfall conditions in Example 1 of the present invention, Example 3 provides a simulation experimental method for scouring and erosion damage or scouring-erosion coupling damage process of accumulation slope surface under long-term rainfall conditions, comprising:

Long duration rainfall and surface runoff simulation: Open the main valve 20 in the water supply subsystem, adjust the rainfall control valve 10 in the rainfall simulation subsystem and the surface runoff control valve 16 in the surface runoff simulation subsystem; Place a rainfall gauge at the bottom of the rainfall simulation device, and adjust the rainfall intensity adjustment knob 58, rainfall spray range adjustment knob 59, and nozzle 60 according to the experimental design plan to achieve a rainfall of 10-100 mm/24 h. In addition, the rainfall can be controlled by adjusting the main valve 20 to achieve the purpose of intermittent long-term rainfall; Convert surface runoff flow rate and velocity based on the set rainfall amount, and adjust them through surface runoff control valve 16; The other end of the main water pipe 22 in the water supply subsystem is connected to the wastewater collection tank 36. The wastewater collection tank 36 is connected to the communicating pipe 38 of the water supply collection tank, and the communicating pipe 38 of the water supply collection tank is connected to the water supply tank 19. The main water pipe 22, the wastewater collection tank 36, the communicating pipe 38 of the water supply collection tank, and the water supply tank 19 form an atmospheric precipitation cycle simulation system, ensuring that the simulation device can continuously supply rainfall for a long time, thus achieving the simulation of long-term rainfall conditions.

Slope surface simulation of different slope accumulation bodies: The slope angle of adjustable slope surface 38 is controlled by the slope adjustment subsystem to place the slope surface horizontally; Reduce the slope of the accumulation body according to the actual engineering model scale, with an initial dam height of 0.2 m, an initial dam slope of 1:2, a sub dam height of 0.1 m, and a sub dam slope of 1:2. The sedimentary beach is made of loose accumulation material, and the particle size is determined according to the sedimentation rules in actual engineering.

Analysis of the scouring and erosion damage process of the slope of the accumulation body: comprising infiltration line monitoring device, particle transport monitoring device, accumulation deformation monitoring device, and pore water pressure monitoring device; The infiltration line monitoring device comprises an infiltration line monitoring tube connection port 52 and an infiltration line monitoring data export port 53; The particle transport monitoring device comprises a scouring particle weighing platform 32, an erosion particle weighing platform 33, and a rainwater weighing platform 34. The scouring particle collection tank 23 is located at the top layer, the erosion particle collection tank 24 is located at the middle layer, and the rainwater collection tank 25 is located at the bottom layer. The scouring particle collection tank 23, the erosion particle collection tank 24, and the rainwater collection tank 25 overlap with each other and are sealed around; The flushing particle collection tank 23 is connected to the flushing particle guide pipe 26, which guides the flushed particles into the flushing particle collection box 29. The bottom of the flushing particle collection box 29 is equipped with a flushing particle weighing platform 32, which can display the weight of the flushed particles in real time; The erosion particle collection tank 24 is connected to the erosion particle guide pipe 27, which guides the eroded particles into the erosion particle collection box 30. The bottom of the erosion particle collection box 30 is equipped with an erosion particle weighing platform 33, which can display the weight of the eroded particles in real time; The rainwater collection tank 25 is connected to the rainwater diversion pipe 28. The rainwater diversion pipe 28 guides the accumulation rainwater into the rainwater collection box 31. The bottom of the rainwater collection box 31 is equipped with a rainwater weighing platform 34, which can display the weight of the accumulation rainwater in real time; The deformation monitoring device for the accumulation body comprises an equipment hanger 54, a ball head connection port 55, and a laser radar scanner 56. The equipment hanger 54 is connected to the movable crossbeam 4 in the support system, and the ball head connection port 55 is connected to the laser radar scanner 56. The monitoring height and angle of the laser radar scanner 56 can be adjusted through the equipment hanger 54 and the ball head connection port 55. The laser radar scanner 56 can monitor the starting and transportation process of loose accumulation material particles and the deformation and failure process of the accumulation body in real time; The pore water pressure monitoring device is uniformly arranged inside the accumulation body; The infiltration line monitoring device, particle transport monitoring device, accumulation deformation monitoring device, and pore water pressure monitoring device are connected to a computer to obtain real-time monitoring data on changes in the infiltration line, particle initiation and transport, gradual failure process of the accumulation, failure location of the accumulation, and changes in pore water pressure.

Although preferred embodiments of the present invention have been described, those skilled in the art may make additional changes and modifications to these embodiments once they have knowledge of the basic inventive concept. Therefore, the attached claims are intended to be interpreted as comprising preferred embodiments and all changes and modifications falling within the scope of the present invention.

Obviously, technicians in this field can make various modifications and variations to the present invention without departing from the spirit and scope of the invention. Thus, if these modifications and variations of the present invention fall within the scope of the claims and their equivalent technologies, the present invention is also intended to comprise these modifications and variations.

1. A simulation testing device for scouring and erosion damage of an accumulation slope under rainfall conditions, comprising a water supply subsystem, a rainfall simulation subsystem, and an accumulation slope simulation subsystem,
The water supply subsystem comprises a water supply tank (19) and a main water pipe (22), wherein the water supply tank (19) can be used to store test water;
The rainfall simulation subsystem comprises a rainfall nozzle (13), and the accumulation slope simulation subsystem comprises an adjustable slope surface (39), the outlet of the rainfall nozzle (13) has a first set distance from the adjustable slope surface (39);
The water supply tank (19) is communicated to the rainfall nozzle (13) through the main water pipe (22), and the forward projection of the rainfall nozzle (13) on the adjustable slope surface (39) includes the adjustable slope surface (39), so that the test water can sequentially fall onto the adjustable slope surface (39) through the main water pipe (22) and the rainfall nozzle (13).

2. The simulation testing device for scouring and erosion damage of the accumulation slope under rainfall conditions according to claim 1, it further comprises a horizontal slope surface (40),
The horizontal slope surface (40) is fixedly connected to the adjustable slope surface (39) through one side edge,
The forward projection of the rainfall nozzle (13) on the adjustable slope surface (39) also includes the horizontal slope surface (40).

3. The simulation testing device for scouring and erosion damage of the accumulation slope under rainfall conditions according to claim 1, it further comprises a slope adjustment mechanism, wherein the slope adjustment mechanism comprises a base (48), a first connecting rod (50), a second connecting rod (51), a third connecting rod (61), and a telescopic mechanism (49),
One end of the first connecting rod (50) is fixedly connected to the bottom of the adjustable slope surface (39), and the other end of the first connecting rod (50) is hinged to one end of the third connecting rod (61), forming a guide rail pair between the other end of the third connecting rod (61) and the base (48);
One end of the second connecting rod (51) is fixedly connected to the bottom of the adjustable slope surface (39), and the other end of the second connecting rod (51) forms a guide rail pair with the base (48);
The second link (51) and the third link (61) are hinged at a hinge point, which is set between the two ends of the second link (51), and the hinge point is also set between the two ends of the third link (61);
One end of the telescopic mechanism (49) is fixedly connected to the base (48), and the other end of the telescopic mechanism (49) is hinged to the second connecting rod (51);
Make the connection point between the first connecting rod (50) and the bottom of the adjustable slope surface (39) the first point, and the connection point between the second connecting rod (51) and the bottom of the adjustable slope surface (39) the second point, with a second set distance between the first and second points.

4. The simulation testing device for scouring and erosion damage of the accumulation slope under rainfall conditions according to claim 2, the bottom of the adjustable slope surface (39) and the horizontal slope surface (40) are sequentially provided with a geomembrane (41) and a rainwater diversion groove (43) from top to bottom;
it further comprises an interception mechanism and a collection subsystem,
The interception mechanism is located downstream of the horizontal slope surface (40), and comprises a first interception part (46) and a second interception part in sequence from top to bottom. The first interception part (46) is physical, and the second interception part is a barrier structure,
The collection subsystem comprises a flushing particle collection tank (23), an erosion particle collection tank (24), and a rainwater collection tank (25),
The first interception part (46) corresponds to the erosion particle collection groove (23), the second interception part corresponds to the erosion particle collection groove (24), and the rainwater diversion groove (43) corresponds to the rainwater collection groove (25).

5. The simulation testing device for scouring and erosion damage of the accumulation slope under rainfall conditions according to claim 4, it further comprises an infiltration line monitoring tube (42),
The infiltration line monitoring tube (42) is arranged between the geomembrane (41) and the rainwater diversion channel (43),
One end of the infiltration line monitoring tube (42) is provided with a first infiltration line monitoring tube connection port (52), which is located on the surface of the adjustable slope surface (39) and the horizontal slope surface (40),
The other end of the infiltration line monitoring tube (42) terminates at the plane where the interception mechanism is located.

6. The simulation testing device for scouring and erosion damage of the accumulation slope under rainfall conditions according to claim 4, the opening of the collection subsystem gradually narrows from the interception mechanism to the end of the collection subsystem;
the bottom surface of the rainwater diversion groove (43) is located at the bottom of the horizontal slope surface (40), and the height of the bottom surface of the rainwater diversion groove (43) gradually decreases from the junction of the adjustable slope surface (39) and the horizontal slope surface (40) to the interception mechanism.

7. The simulation testing device for scouring and erosion damage of the accumulation slope under rainfall conditions according to claim 4, the collection subsystem further comprises an erosion particle guide pipe (26), an erosion particle guide pipe (27), a rainwater guide pipe (28), an erosion particle collection box (29), an erosion particle collection box (30), and a rainwater collection box (31),
The flushing particle collection tank (23) is communicated to the flushing particle collection box (29) through the flushing particle guide pipe (26);
The erosion particle collection tank (24) is communicated to the erosion particle collection box (30) through the erosion particle guide pipe (27);
The rainwater collection tank (25) is communicated to the rainwater collection box (31) through the rainwater diversion pipe (28).

8. The simulation testing device for scouring and erosion damage of the accumulation slope deposits under rainfall conditions according to claim 7, it further comprises an erosion particle weighing platform (32), an erosion particle weighing platform (33), and rainwater weighing platform (34),
The setting position of the scouring particle weighing platform (32) corresponds to the setting position of the scouring particle collection box (29), and the scouring particle weighing platform (32) is used to weigh the scouring particles collected in the scouring particle collection box (29);
The installation position of the erosion particle weighing platform (33) corresponds to the installation position of the erosion particle collection box (30), and the erosion particle weighing platform (33) is used to weigh the erosion particles collected in the erosion particle collection box (30);
The position of the rainwater weighing platform (34) corresponds to the position of the rainwater collection box (31), and the rainwater weighing platform (34) is used to weigh the rainwater collected in the rainwater collection box (31).

9. The simulation testing device for scouring and erosion damage of the accumulation slope under rainfall conditions according to claim 7, it further comprises a wastewater collection tank (36) and a wastewater communicating pipe (35),
The scouring particle collection box (29), erosion particle collection box (30), and rainwater collection box (31) are respectively communicated to the wastewater collection box (36) through the wastewater communicating pipe (35).

10. The simulation testing device for scouring and erosion damage of the accumulation slope erosion under rainfall conditions according to claim 9, it further comprises a wastewater filter screen (37),
The wastewater filter screen (37) is installed inside the wastewater collection tank (36), so that the wastewater collection tank (36) is divided into independent first and second storage spaces by the wastewater filter screen (37). The flushing particle collection tank (29), erosion particle collection tank (30), and rainwater collection tank (31) are respectively communicated to the wastewater collection tank (36) through the wastewater communicating pipe (35).

11. The simulation testing device for scouring and erosion damage of the accumulation slope erosion under rainfall conditions according to claim 10, it further comprises a communicating pipe (38) for the water collection tank,
The second storage space is communicated to the water supply subsystem through the water collection tank communicating pipe (38).

12. The simulation testing device for scouring and erosion damage of the accumulation slope under rainfall conditions according to claim 1, it further comprises a bracket,
The main water pipe (22) and the rainfall nozzle (13) are set at designated positions through the bracket;
it further comprises moving casters (8),
The mobile casters (8) are set on the support legs of the bracket, so that the bracket can move based on the mobile casters (8).

13. The simulation testing device for scouring and erosion damage of the accumulation slope under rainfall conditions according to claim 12, it further comprises a first suspension cable,
The rainfall nozzle (13) and/or the adjustable slope surface (39) are suspended from the bracket by the first suspension cable.

14. The simulation testing device for scouring and erosion damage of the accumulation slope under rainfall conditions according to claim 1, it further comprises a surface runoff water pipe (15) and a surface runoff control valve (16),
The water supply tank (19) is communicated to one end of the surface runoff pipe (15) through the main water pipe (22), and the other end of the surface runoff pipe (15) is the surface runoff outlet (18), which is set at the high end of the adjustable slope surface (39).

15. The simulation testing device for scouring and erosion damage of the accumulation slope under rainfall conditions according to claim 5, it further comprises an analysis subsystem for scouring and erosion damage process of the accumulation slope, wherein the analysis subsystem for scouring and erosion damage process of accumulation slope comprises:
The second infiltration line monitoring tube connection port is used to obtain monitoring data from the first infiltration line monitoring tube connection port (52);
A laser radar scanner is used to obtain monitoring image data within a monitoring field of view, wherein the monitoring field of view comprises the field of view range of the adjustable slope (39) and/or the horizontal slope (40);
The second suspension cable (54) suspends the laser radar scanner at the set position.

16. The simulation testing device for scouring and erosion damage of the accumulation slope under rainfall conditions according to claim 15, it further comprises a ball joint connector (55),
The second suspension cable (54) is connected to the laser radar scanner through the ball joint connector (55).

17. The simulation testing device for scouring and erosion damage of the accumulation slope deposits under rainfall conditions according to claim 15, the analysis method of the scouring and erosion damage process analysis subsystem of the slope deposits comprises the following steps:
Obtain monitoring data from the infiltration line monitoring tube of the adjustable slope surface (39) and/or the horizontal slope surface (40), and/or,
Obtain monitoring image data of the adjustable slope surface (39) and/or the horizontal slope surface (40);
Based on the monitoring data of the infiltration line monitoring tube of the adjustable slope surface (39) and/or the horizontal slope surface (40), and/or the monitoring image data of the adjustable slope surface (39) and/or the horizontal slope surface (40), perform data calculation to obtain the data calculation result;
Based on the data calculation results, obtain the analysis conclusion of the subsystem for analyzing the scouring and erosion damage process of the slope of the accumulation body.

18. The simulation testing device for scouring and erosion damage of the accumulation slope under rainfall conditions according to claim 17, based on the monitoring data of the infiltration line monitoring tube of the adjustable slope surface (39) and/or the horizontal slope surface (40), and/or the monitoring image data of the adjustable slope surface (39) and/or the horizontal slope surface (40), data calculation is performed to obtain the data calculation result, which specifically comprises the following steps:
Input the monitoring data of the infiltration line monitoring tube of the adjustable slope surface (39) and/or the horizontal slope surface (40), and/or the monitoring image data of the adjustable slope surface (39) and/or the horizontal slope surface (40) into a pre-trained mathematical model;
The mathematical model performs data operations to obtain data operation results.

19. The simulation testing device for scouring and erosion damage of the accumulation slope under rainfall conditions according to claim 18, the monitoring data of the infiltration line monitoring tube of the adjustable slope surface (39) and/or the horizontal slope surface (40), and/or the monitoring image data of the adjustable slope surface (39) and/or the horizontal slope surface (40) are input into a pre-trained mathematical model, and the training method of the pre-trained mathematical model comprises the following steps:
Obtain monitoring data of the infiltration line monitoring tubes of the adjustable slope surface (39) and/or the horizontal slope surface (40), and/or historical monitoring sample data of the monitoring image data of the adjustable slope surface (39) and/or the horizontal slope surface (40), wherein the monitoring data of the infiltration line monitoring tubes of the adjustable slope surface (39) and/or the horizontal slope surface (40), and/or the historical monitoring sample data of the monitoring image data of the adjustable slope surface (39) and/or the horizontal slope surface (40) are historical monitoring sample data with known analysis conclusions;
Input the monitoring data of the infiltration line monitoring tube of the adjustable slope surface (39) and/or the horizontal slope surface (40), and/or the historical monitoring sample data of the monitoring image data of the adjustable slope surface (39) and/or the horizontal slope surface (40) into the selected mathematical model;
Based on the monitoring data of the infiltration line monitoring tube of the adjustable slope surface (39) and/or the horizontal slope surface (40), and/or the analysis conclusion of the historical monitoring sample data of the monitoring image data of the adjustable slope surface (39) and/or the horizontal slope surface (40), adjust the parameters of the selected mathematical model to obtain the pre-trained mathematical model;
in the step of inputting the monitoring data of the infiltration line monitoring tube of the adjustable slope surface (39) and/or the horizontal slope surface (40), and/or the historical monitoring sample data of the monitoring image data of the adjustable slope surface (39) and/or the horizontal slope surface (40) into the selected mathematical model, the selected mathematical model comprises multiple.

20. The simulation testing device for scouring and erosion damage of the accumulation slope under rainfall conditions according to claim 19, the monitoring data of the infiltration line monitoring tube of the adjustable slope surface (39) and/or the horizontal slope surface (40), and/or the monitoring image data of the adjustable slope surface (39) and/or the horizontal slope surface (40) are input into the pre-trained mathematical model during the step process, and the training method of the pre-trained mathematical model further comprises the following steps:
The monitoring data of the infiltration line monitoring tube of the adjustable slope surface (39) and/or the horizontal slope surface (40) currently being monitored, and/or the monitoring image data of the adjustable slope surface (39) and/or the horizontal slope surface (40), as well as the analysis conclusion of the scouring and erosion damage process of the accumulation slope obtained from the monitoring data of the infiltration line monitoring tube of the adjustable slope surface (39) and/or the horizontal slope surface (40) currently being monitored, are automatically added to the historical monitoring sample data.
